(19) United States
(12) Patent Application Publication
(10) Pub. No.: US 2014/0369300 A1
(43) Pub. Date: Dec. 18, 2014

(54) Iterative Interference Cancellation Method

(71) Applicant: Huawei Technologies Co., Ltd., Shenzhen (CN)

(72) Inventors: Sha Hu, Shanghai (CN); Gengshi Wu, Shanghai (CN); Basuki Endah Priyanto, Kista (SE); Fredrik Rusek, Lund (SE); Shashi Kant, Kista (SE); Jianjun Chen, Kista (SE)

(21) Appl. No.: 14/459,464

(22) Filed: Aug. 14, 2014

Related U.S. Application Data
(63) Continuation of application No. PCT/EP2013/054821, filed on Mar. 11, 2013.

(51) Int. Cl. H04B 7/005; H04W 72/04

(52) U.S. Cl. CPC H04B 7/005; H04W 72/0406
USPC 370/329

(57) ABSTRACT

The present disclosure relates to an iterative pilot symbol interference cancellation method in a receiver node of a cellular wireless communication system. The method includes receiving a superimposed signal comprising pilot symbols and data symbols associated with a serving cell and pilot symbols associated with one or more interfering cells, extracting a first set from the superimposed signal. The first set includes a plurality of data symbols associated with said serving cell which are affected by an interference from the one or more interfering cells. The method further includes estimating an interference of the first set, removing interference from the first set using the estimated interference, estimating the plurality of data symbols, subtracting the estimated plurality of data symbols from the first set, and repeating the estimating an interference, the removing interference, the estimating plurality of data symbols, and the subtracting steps i number of times, where i≧1.

### CROSS-REFERENCE TO RELATED APPLICATIONS

This application is a continuation of International application No. PCT/EP2013/054821, filed on Mar. 11, 2013, which is hereby incorporated by reference in its entirety.

### TECHNICAL FIELD

The present disclosure relates to an interference cancellation method in a receiver node. Furthermore, the disclosure also relates to a receiver node device, a computer program, and a computer program product thereof.

### BACKGROUND

In Orthogonal Frequency Division Multiplexing (OFDM) systems, such as Long Term Evolution (LTE) and LTE-Advanced (LTE-A), pilot symbols are inserted into data symbols according to a pre-designed pattern and transmitted together with the data. At the receiver side, based on the known pilot symbols, an User Equipment (UE) can estimate the Channel State Information (CSI) which is used for data detection. Usually the amount of pilot symbols is kept small in order to reduce the overhead of the communication system which makes the CSI estimation (CE) more challenging.

In principle, the UE will first estimate the CSI at pilot positions and then use the estimation to interpolate the CSI at the data positions based on Winner filter criterion. In order to guarantee the estimation performance, the transmit power of pilot symbols is usually boosted and higher than the transmit power of data symbols.

Hence, when the UE operates in a multi-cell scenario, the pilot symbol transmissions from interfering cells will cause more interference than the data transmission from the interfering cells. Also in LTE/LTE-A the conception of Almost Blank Sub-frame (ABS) has been introduced for the cooperation between neighboring Evolved Node Base Stations (eNBs) to reduce the downlink transmission. The serving cell will schedule the downlink data transmission when interfering cells are transmitting ABS. In this case there is no interference caused by data symbols from the interfering cells. However, the pilot symbols from the interfering cells are still transmitted for channel measurements and reporting at the receiver side, which means the receiver node will only suffer the interference from the pilot symbols from the interfering cells. The above indicates that a better Interference Cancellation (IC) for the pilot interference in such pilot-based OFDM systems under multi-cell scenario is needed.

Depending on the network configuration under a multi-cell scenario, the transmitted pilot pattern of interfering cell can be either the same as, or different from, the pilot pattern of the serving cell. This means when the serving cell suffers from interference caused by pilot symbols of the interfering cell, the interference can either interfere with pilot symbols or data symbols of the serving cell. In the case there is more than one interfering cell, the pilot interference from different cells can collide with both the data symbols and the pilot symbols of the serving cell at the same time.

According to a first prior art solution, at receiver side, the UE estimates the CSI of interfering cells and thereafter subtracts the regenerated interference signal from the received signal before demodulation of the serving cell data. However, the first prior art solution suffers from the inaccurate CE of interfering cells due to the transmitted data symbols of serving cell is unknown at the receive node. Without any information about the transmitted data symbols from the serving cell, the transmitted data symbols have to be regarded as noise and therefore it will degrade the interference estimation performance.

According to a second prior art solution the UE sets all the Log-likelihood Ratio (LLR) values at the polluted data positions to zero prior to decoding. However, the second prior art solution suffers from the fact that the data information at polluted positions is missing as the LLR values are muted at these positions. Therefore, the decoding performance will be degraded. Moreover, if all the data positions are suffering from interference, the LLR muting is not applicable anymore.

### SUMMARY

An object of the present disclosure is to provide a solution which mitigates or solves the drawbacks and/or the problems of prior art solutions.

Another object is to provide a solution which has improved performance compared to prior art solutions.

According to a first aspect of the disclosure, the above mentioned objects are achieved by an iterative pilot symbol interference cancellation method in a receiver node of a cellular wireless communication system, said receiver node being arranged to receive one or more superimposed signals originating from at least one serving cell and one or more interfering cells. The method comprises receiving a superimposed signal comprising pilot symbols and data symbols associated with a serving cell and pilot symbols associated with one or more interfering cells and extracting a first set from said superimposed signal. The first set comprises a plurality of data symbols associated with said serving cell which are affected by an interference from said one or more interfering cells. The method further includes estimating an interference of said first set, removing interference from said first set using the estimated interference, estimating said plurality of data symbols, subtracting the estimated plurality of data symbols from said first set, and repeating the estimating an interference, the removing interference, the estimating plurality of data symbols, and the subtracting steps i number of times, where i≧1.

According to a first aspect of the disclosure, the above mentioned objects are achieved with a receiver node device of a cellular wireless communication system. The receiver node comprises processing means and memory means arranged to receive one or more superimposed signals originating from at least one serving cell and one or more interfering cells. The receiver node device further comprises receiving means arranged for receiving a superimposed signal comprising pilot symbols and data symbols associated with a serving cell and pilot symbols associated with one or more interfering cells, extracting means arranged for extracting a first set from said superimposed signal, wherein said first set comprises a plurality of data symbols associated with said serving cell which are affected by an interference from said one or more interfering cells, estimating means arranged for estimating an interference of said first set, removing means arranged to removing interference from said first set by means of the estimated interference, estimating means arranged for estimating said plurality of data symbols, subtracting means arranged for subtracting the estimated plurality of data symbols from said first set, and repeating means arranged so that steps c)-f) are repeated i number of times, where i≧1.

The present solution provides an improved performance due to the fact that the transmitted data information feedback from demodulator or decoder is utilized and that the data of the serving cell is subtracted prior to interference estimation. Thereby, the interference estimation accuracy is improved and thus renders a better downlink performance.

Also the present solution according to some embodiments employs Space-Alternating Generalized Expectation-Maximization (SAGE)—Maximum a Posterior (MAP) based algorithm both for the serving cell CSI estimation and interference estimation which provides good performance when there are more than one interfering cells. The SAGE-MAP algorithm can be implemented in hardware or on Digital Signal Processing (DSP) and the components can be reused by CSI estimation and interference cancellation.

Furthermore, according to an embodiment, a Linear Minimum Mean Square Error (LMMSE)—Parallel Interference Cancellation (PIC) algorithm is employed as the detector for Multi-Input Multi-Output (MIMO) case which can further boost the data detection performance with the present disclosure.

Further applications and advantages of the disclosure will be apparent from the following detailed description.

### BRIEF DESCRIPTION OF THE DRAWINGS

The appended drawings are intended to clarify and explain different embodiments of the present disclosure in which:

FIG. 1 illustrates the extraction of data affected by interference, i.e. suffer from interference originating from interfering cells;

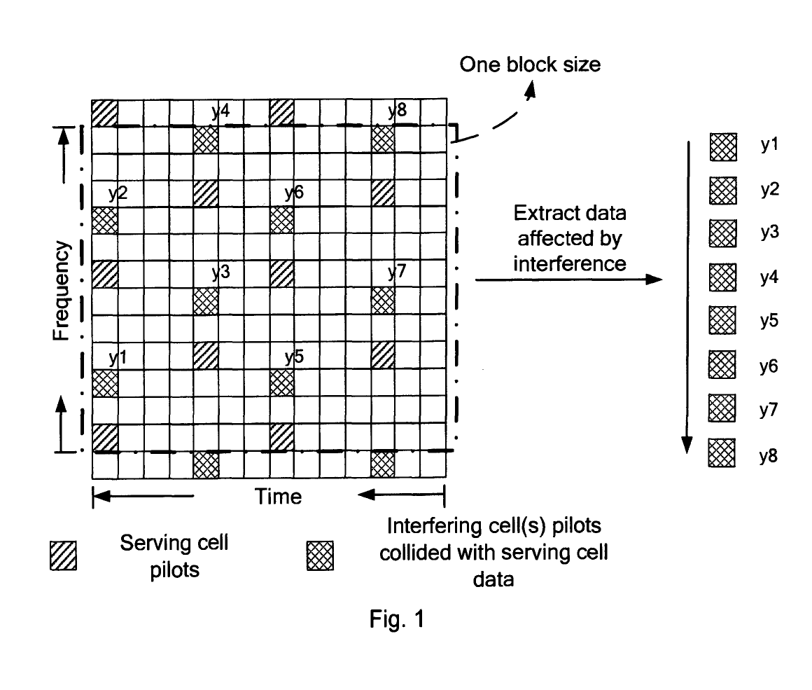

FIG. 2 illustrates a first embodiment of the present disclosure;

FIG. 3 illustrates a second embodiment of the present disclosure;

FIG. 4 illustrates a third embodiment of the present disclosure;

FIG. 5 shows performance results for the present disclosure; and

FIG. 6 shows further performance results for the present disclosure.

### DETAILED DESCRIPTION

To achieve the aforementioned and further objects, the present disclosure relates to an iterative pilot symbol interference cancellation method in a receiver node of a cellular wireless communication system. The receiver node is arranged to receive one or more superimposed signals originating from at least one serving cell and one or more interfering cells which often are the neighboring cells of the serving cell. The serving cell serves the receiver node which means that the receiver node performs the detection of the data symbols transmitted from serving cell. In order to achieve better data detection performance, the interference from one or more interfering cells should be taken into consideration when detecting the data symbols of the serving cell.

The cellular system may according to an embodiment of the disclosure be a system (e.g. an OFDM system) that uses time/frequency Resource Elements (REs) for transmission of radio signals. The mentioned radio signals may comprise different channels and/or pilot symbols, and the channels may e.g. be broadcast channels, control channels, synchronization channels and data channels, while the pilot symbols may be Common Reference Symbol (CRS) or any other pilot symbols used in the system. The cellular system may preferably be a system specified by the 3rd Generation Partnership Project (3GPP), such as LTE or LTE Advanced according to relevant specifications.

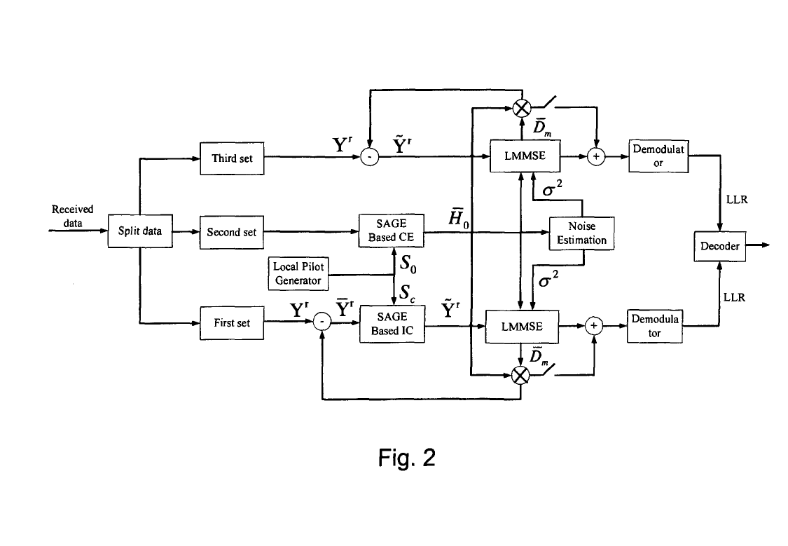

FIG. 2 illustrates the extraction of data affected by interference, i.e., suffer from interference originating from interfering cells. The present iterative method for interference cancellation comprises the steps of: a) receiving a superimposed signal comprising pilot symbols and data symbols associated with the serving cell and pilot symbols associated with one or more interfering cells; b) extracting a first set from the superimposed signal, wherein the first set comprises a plurality of data symbols associated with the serving cell which are affected by an interference from the one or more interfering cells; c) estimating an interference of the first set; d) removing interference from the first set by means of the estimated interference; e) estimating the plurality of data symbols; f) subtracting the estimated plurality of data symbols from the first set; and g) repeating steps c)-f) i number of times, where i is an integer and i≧1. A large value for i will render better downlink performance since the receiver will iterate more times but with the cost of higher complexity and process latency in the receiver. The performance gain is also getting smaller as the number of iterations increases, therefore in reality the iteration number i can be set equal to 1 or 2 which can provide promising performance gain with reasonable cost.

The present iterative method provides a solution with improved performance compared to prior art solutions. This is because the iterative method improves the interference estimation resulting in better decoding performance.

According to an embodiment of the disclosure the steps of estimating the interference and removing the interference are performed according to a Space-Alternating Generalized Expectation-Maximization with Maximum a Posterior, SAGE-MAP, method.

With reference to this embodiment shown in FIG. 2: generally the received superimposed signal at the receiver side can be split in to three sets, namely: the first set which comprises the plurality of data symbols associated with the serving cell which are affected by interference from one or more interfering cells; the second set which comprises pilot symbols associated with the serving cell and which are affected by the interference; and the third set which comprises a plurality of data symbols associated with the serving cell which are not affected by the interference.

The received second set is used for CE of the serving cell. When it suffers pilot interference from interfering cells, the CE needs to be obtained from superimposed received signal. Because all the transmitted pilot information is known at the receiver side, the SAGE-MAP algorithm can be used to decompose the superimposed signal and obtain the CE for the serving cell at pilot positions. Followed by a Winner filtering, the CE for data positions in first and third sets can be obtained.

Moreover, the received first and third sets are used for data detection with the CE obtained from the second set. The received third set is interference free so the data symbols detection is the same as in the single cell case. The received first set suffers pilot interference from the interfering cells. The SAGE-MAP algorithm can be used to decompose the superimposed signal and remove the interference. However, as the transmitted serving cell data is unknown at the receiver side, the interference estimation accuracy is degraded and hence the present disclosure proposes an iterative interference cancellation algorithm to utilize the data information feedback from the detector or decoder to improve the interference estimation. It should be noted that for the processing of the second set, all transmitted pilot symbols are already known at the receiver side and no iterative structure is needed, while for the processing of the third set no interference cancellation is needed and thus only implements data detection.

The iterative pilot interference cancellation structure mainly refers to the process of receiving the first signal set and it includes two parts: SAGE-MAP based interference estimation and according to an embodiment LMMSE-PIC based data detection. In an iterative structure, the data feedback from data detection part is first removed from the original received signal before interference estimation and after that the estimated interference is also removed from the received signal before data detection. It can be implemented in an iterative scheme to improve the interference estimation accuracy and render a better data performance. Hence, according to another embodiment of the disclosure the step of estimating the plurality of data symbols is performed according to LMMSE-PIC method.

Further, for a thorough understanding of present disclosure a radio signal propagation model, the SAGE-MAP and LMMSE-PIC algorithms are presented more closely in the following description.

Radio Signal Propagation Considerations

Generally there could be some time delay between the interfering cell(s) and the serving cell. Assuming that the received signal at the receiver node is synchronized with the serving cell and the time delay between an interfering cell and the serving cell is τ samples (τ is less than the Cyclic Prefix (CP) length), after removing the CP and implementing N (available subcarrier number according to specific network configuration) point Fast Fourier Transform (FFT) to the received time domain samples at UE side, the transmitted signal of the interfering cell in frequency index k will be rotated by a factor that depends on index k and time delay τ as:

$$\tilde{s} ( k ) = {\sum }_{i = 0}^{N - 1} S ( i + τ ) {e}^{- j 2 π ik / N} = \frac{1}{N} {\sum }_{i = 0}^{N - 1} {\sum }_{m = 0}^{N - 1} s ( m ) {e}^{j 2 π ( i + τ ) m / N} {e}^{- j 2 π ik / N} = s ( k ) {e}^{j 2 π τ k / N} . \qquad ( 1 )$$

There could also be some transmit power offset between the interfering cell(s) and the serving cell. In the present model it is assumed that the transmit power of each cell is equally distributed to every transmitted antenna which is a common assumption in most cases and the total transmit power of the serving cell is normalized to one. If there is a power offset factor Δp between the interfering cell and the serving cell, both the power offset factor Δp and rotate factor e^{j2πτk/N} are modeled into the “effective” transmitted pilot \tilde{s}(k)=\sqrt{Δp}e^{j2πτk/N} s(k) (0≦k<N) at each frequency index k at receiver node side instead of original pilot s(k). In the rest of this disclosure, if not otherwise stated, the “pilot” always refers to the “effective pilot” for simplicity of description which means the time delay and power offset effects between interfering cell(s) and serving cell are implicitly included in the effective pilot in the received signal models.

SAGE-MAP Based CE

For a linear received signal model:

$$Y = {\sum }_{c = 0}^{C - 1} {S}_{c} {H}_{c} + W , \qquad ( 2 )$$

where Y=(y(0), y(1), . . . y(K−1))^{T} is the column vector of received signal. K is the number of received samples exploited for estimation. S_{c}=diag(s_{c}(0), s_{c}(1), . . . s_{c}(K−1)) is the diagonal matrix of the transmitted pilot symbols that are known at the UE side (i.e. effective pilots) of cell index c (c=0 corresponds to serving cell) and satisfies S_{c}(S_{c})^{H}=Δp_{c}I_{K}. Δp_{c}(1≦c<C) is the power offset between interfering cell and serving cell and the power of serving cell Δp₀ is 1. H_{c}=(h_{c}(0), h_{c}(1), . . . , h_{c}(K−1))^{T} is the column vector of CSI of cell index c which needs to be estimated. W=(w(0), w(1), . . . w(K−1))^{T} is the column vector of Additional White Gaussian Noise (AWGN) and W˜N(0,Σ), Σ=diag (ε(0), ε(1), . . . ε(K−1)) is the K×K covariance matrix.

By applying the commonly used decomposition method of the noise and define:

Y_{c}=S_{c}H^{c}+W_{c} (3),

where W_{c}=(w_{c}(0), w_{c}(1), . . . w_{c}(K−1))^{T} and satisfies

$${\sum }_{c = 0}^{C - 1} {W}_{c} = W$$

$$and$$

$${β}_{c} = \frac{var ( {w}_{c} ( k ) )}{ɛ ( k )} , \\ 0 \leq k < K .$$

β_{c} can be arbitrary positive value and only needs to satisfy

$${\sum }_{c = 0}^{C - 1} {β}_{c} = 1.$$

Define the diagonal matrix and column B=diag (β₀, β₁, . . . β_{C-1}), Ω=diag(S₀, S₁, . . . S_{C-1}) and column vectors Φ=((Y₀)^{T}, (Y₁)^{T}, . . . , (Y_{C-1})^{T}), Λ=((H₀)^{T}, (H₁)^{T}, . . . , (H_{C-1})^{T}), Δ((W₀)^{T}, (W₂)^{T}, . . . , (W_{C-1})^{T}).

Then Φ is the so-called “complete data” and Y is “incomplete data”. The covariance matrix corresponding to noise vector Δ and channel vector Λ is R_{Λ}=B⊖Σ and R_{Λ}=diag(R₀, R₁, . . . R_{C-1}), respectively. Here, R_{c} is the covariance matrix of H_{c} (0≦c<C). In Expectation-Maximization (EM)-MAP algorithm, the E-step at (i+1)-th iteration is to calculate the conditional expectation based on the CE Λⁱ=((H₀ⁱ)^{T}, (H₁ⁱ)^{T}, . . . , (H_{C-1}ⁱ)^{T}) at i-th iteration:

$${E}_{Φ} ( log p ( Φ \vert Λ ) \vert Y , {Λ}^{i} ) + log p ( Λ ) = {\sum }_{Φ}^{ } ( log p ( Φ \vert Λ ) ) p ( Φ \vert Y , {Λ}^{i} ) + log p ( Λ ) = {\sum }_{Φ}^{ } ( - \frac{1}{2} ( Φ - Λ Ω ) {{R}_{Δ}^{- 1} ( Φ - Λ Ω )}^{H} + log ( {( 2 π )}^{CK / 2} {\vert {R}_{Δ} \vert}^{1 / 2} ) ) p ( Φ \vert Y , {Λ}^{i} ) - \frac{1}{2} Λ {R}_{Λ}^{- 1} {Λ}^{H} + log ( {( 2 π )}^{CK / 2} {\vert {R}_{Λ} \vert}^{1 / 2} ) = - \frac{1}{2} {\sum }_{Φ}^{ } ( ( Φ - Λ Ω ) {{R}_{Δ}^{- 1} ( Φ - Λ Ω )}^{H} p ( Φ \vert Y , {Λ}^{i} ) ) - \frac{1}{2} Λ {R}_{Λ}^{- 1} {Λ}^{H} + log ( {( 2 π )}^{CK} {\vert {R}_{Δ} {R}_{Λ} \vert}^{1 / 2} ) \qquad ( 4 )$$

Taking the derivation of Λ^{H} leads to the estimation that maximizes the conditional expectation at (i+1)-th iteration:

$$\begin{matrix}{Λ}^{i + 1} = ( {\sum }_{Φ}^{ } Φ p ( Φ \vert Y , {Λ}^{i} ) ) {R}_{Δ}^{- 1} {{Ω}^{H} ( Ω {R}_{Δ}^{- 1} {Ω}^{H} + {R}_{Λ}^{- 1} )}^{- 1} \\ = ( {\sum }_{Φ}^{ } Φ p ( Φ \vert Y , {Λ}^{i} ) ) {( {Ω}^{H} {R}_{Λ} Ω + {R}_{Δ} )}^{- 1} {Ω}^{H} {R}_{Λ} .\end{matrix} \qquad ( 5 )$$

Assuming that Φ and Y are jointly Gaussian and utilize Gaussian-Markov theorem,

$$\begin{matrix}\begin{matrix}{\sum }_{Φ}^{ } {Φ}^{T} p ( {Φ}^{T} \vert Y , {Λ}^{i} ) = E ( {Φ}^{T} \vert Y , {Λ}^{i} ) \\ = E ( {Φ}^{T} \vert {Λ}^{i} ) + {C}_{{Φ}^{T} Y} {C}_{YY}^{- 1} ( Y - E ( Y \vert {Λ}^{i} ) ) ,\end{matrix} \\ since & ( 6 ) \\ E ( {Φ}^{T} \vert Y , {Λ}^{i} ) = {( {Λ}^{i} Ω )}^{T} \\ Y - E ( Y \vert {Λ}^{i} ) = Y - {\sum }_{c = 0}^{C - 1} {S}_{c} {H}_{c}^{i} \\ {C}_{{Φ}^{T} Y} = E ( ( {Φ}^{T} - E ( {Φ}^{T} ) ) {( Y - E ( Y ) )}^{H} \vert {Λ}^{i} ) = {( {β}_{0} , {β}_{1} , … {β}_{C - 1} )}^{T} ⊗ \sum \\ {C}_{YY} = E ( ( Y - E ( Y ) ) {( Y - E ( Y ) )}^{H} \vert {Λ}^{i} ) = \sum \\ then & ( 7 ) \\ {\sum }_{Φ}^{ } Φ p ( Φ \vert Y , {Λ}^{i} ) = {( {\sum }_{Φ}^{ } {Φ}^{T} p ( {Φ}^{T} \vert Y , {Λ}^{i} ) )}^{T} = {Λ}^{i} Ω + {( ( {( {β}_{0} , {β}_{1} , … {β}_{C - 1} )}^{T} ⊗ \sum ) {\sum }^{- 1} ( Y - {\sum }_{c = 0}^{C - 1} {S}_{c} {H}_{c}^{i} ) )}^{T} = ( {( {S}_{0} {H}_{0}^{i} )}^{T} , {( {S}_{1} {H}_{1}^{i} )}^{T} , … , {( {S}_{C - 1} {H}_{C - 1}^{i} )}^{T} ) + ( {β}_{0} , {β}_{1} , … {β}_{C - 1} ) ⊗ {( Y - {\sum }_{c = 0}^{C - 1} {S}_{c} {H}_{c}^{i} )}^{T} = ( {( {S}_{0} {H}_{0}^{i} + {β}_{0} ( Y - {\sum }_{c = 0}^{C - 1} {S}_{c} {H}_{c}^{i} ) )}^{T} , {( {S}_{1} {H}_{1}^{i} + {β}_{1} ( Y - {\sum }_{c = 0}^{C - 1} {S}_{c} {H}_{c}^{i} ) )}^{T} , … , {( {S}_{C - 1} {H}_{C - 1}^{i} + {β}_{C - 1} ( Y - {\sum }_{c = 0}^{C - 1} {S}_{c} {H}_{c}^{i} ) )}^{T} ) & ( 8 )\end{matrix}$$

And since

(Ω^{H}R_{Λ}Ω+R_{Λ})⁻¹Ω^{H}R_{Λ}=diag((S₀R₀S₀^{H}+β₀Σ)⁻¹S₀^{H}R₀,(S₁R₁S₁^{H}+β₁Σ)⁻¹S₁^{H}R₁, . . . ,(S_{C-1}R_{C-1}S_{C-1}^{H}+β_{C-1}Σ)⁻¹S_{C-1}^{H}R_{C-1}) (9)

Denote

$${\hat{Y}}_{c} = {( {S}_{c} {H}_{c}^{i} + {β}_{c} ( Y - {\sum }_{c = 0}^{C - 1} {S}_{c} {H}_{c}^{i} ) )}^{T} ,$$

U_{c}=S_{c}R_{c}S_{c}^{H}+β_{c}Σ)⁻¹S_{c}^{H}R_{c}, 0≦c<C and combine with equation (5), it gives:

$$\begin{matrix}{Λ}^{i + 1} = ( {\sum }_{Φ}^{ } {Φ}_{p} ( Φ \vert Y , {Λ}^{i} ) ) {( {Ω}^{H} {R}_{Λ} Ω + {R}_{Δ} )}^{- 1} {Ω}^{H} {R}_{Λ} \\ = ( {\hat{Y}}_{0} {U}_{0} , {\hat{Y}}_{1} {U}_{1} , … , {\hat{Y}}_{C - 1} {U}_{C - 1} ) .\end{matrix} \qquad ( 10 )$$

That is,

$$\begin{matrix}{H}_{c}^{i + 1} = {( {Y}_{c} {U}_{c} )}^{T} \\ = {R}_{c} {{S}_{c}^{H} ( {S}_{c} {R}_{c} {S}_{c}^{H} + {β}_{c} \sum )}^{- 1} ( \begin{matrix}{S}_{c} {H}_{c}^{i} + \\ {β}_{c} ( Y - {\sum }_{c = 0}^{C - 1} {S}_{c} {H}_{c}^{i} )\end{matrix} ) \\ = {{R}_{c} ( {R}_{c} + {{β}_{c} ( {S}_{c} )}^{- 1} \sum {( {S}_{c}^{H} )}^{- 1} )}^{- 1} {( {S}_{c} )}^{- 1} ( \begin{matrix}{S}_{c} {H}_{c}^{i} + \\ {β}_{c} ( Y - {\sum }_{c = 0}^{C - 1} {S}_{c} {H}_{c}^{i} )\end{matrix} ) , \\ 0 \leq c < C .\end{matrix} \qquad ( 11 )$$

Hence, the EM-MAP algorithm can be summarized as:

$$for i = 1 \text{:} EMIterNum \\ E - Step \text{:} {\hat{Y}}_{c} = {S}_{c} {H}_{c}^{i} + {β}_{c} ( Y - {\sum }_{c = 0}^{C - 1} {S}_{c} {H}_{c}^{i} ) , \\ 0 \leq c < C \\ M - Step \text{:} {H}_{c}^{i + 1} = {{R}_{c} ( {R}_{c} + {{β}_{c} ( {S}_{c} )}^{- 1} \sum {( {S}_{c}^{H} )}^{- 1} )}^{- 1} {( {S}_{c} )}^{- 1} {\hat{Y}}_{c} , \\ 0 \leq c < C \\ end . \qquad ( 12 )$$

“EMIterNum” is a pre-defined iteration number for EM algorithm. Instead of handling the entire superimposed signal in parallel, the SAGE-MAP algorithm updates the estimation of different cells in an iterative scheme and converges faster than the EM algorithm since it uses an alternative complete data at each iteration step (Jeffrey A. Fessler and Alfred O. Hero, “Space-Alternating Generalized Expectation-Maximization Algorithm”, 1994, IEEE Trans, Vol. 42, No. 10, p2664-2677). Thus, SAGE-MAP algorithm is employed in the present disclosure and it is summarized as follows:

$$for i = 1 \text{:} SAGEIterNum \\ for c = 0 \text{:} C - 1 \\ E \text{-} Step \text{:} {\hat{Y}}_{c} = {S}_{c} {H}_{c}^{i} + ( Y - {\sum }_{c = 0}^{C - 1} {S}_{c} {H}_{c}^{i} ) \\ M \text{-} Step \text{:} {H}_{c}^{i + 1} = {{R}_{c} ( {R}_{c} + {( {S}_{c} )}^{- 1} {Σ ( {S}_{c}^{H} )}^{- 1} )}^{- 1} {( {S}_{c} )}^{- 1} {\hat{Y}}_{c} \\ {H}_{t}^{i + 1} = {H}_{t}^{i} , 0 \leq t < C and t \neq c \\ end \\ end \qquad ( 13 )$$

“SAGEIterNum” is a pre-defined iteration number for SAGE algorithm. In case the noise covariance matrix E is unknown, an online estimation is needed. At each iteration, E can be estimated through,

$$Σ = E ( {ee}^{H} ) and e = Y - {\sum }_{c = 0}^{C - 1} {S}_{c} {H}_{c}^{i} .$$

Because the noise density at each pilot position can be approximated as equal, the estimation can be simplified as

$$Σ = E ( {ee}^{H} ) = \frac{1}{K} ( {e}^{H} e ) {I}_{K} \qquad ( 14 )$$

where I_{K} is the K×K identity matrix.

SAGE-MAP Based IC

In a pilot based OFDM system, such as LTE/LTE-A, the pilot from different transmit antennas are transmitted separately for the convenience of CE at the receiver side. This means that when one transmit antenna transmits pilot symbols, the other transmitting antennas will transmit zeros at the same position. Therefore, the pilots from different transmit antennas from the same interfering cell can be viewed as from one single “virtual” transmitting antenna with combined pilot pattern of different transmit antennas. Hence, at the UE side, for each receive antenna, the interference received from the interfering cells can be viewed as Single Input Single Output (SISO) model. However, the data of the serving cell contains multiple signals from different transmit antennas.

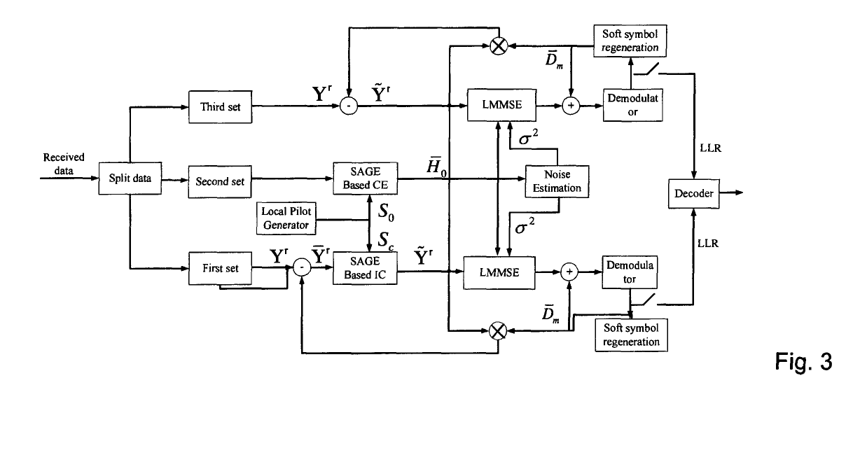

Below a MIMO system with M transmit antenna and R receive antenna is considered. For each receive antenna at the receiver side, the received data suffering from interference is extracted from a specific frequency-time block size for data detection. In LTE/LTE-A the block size can be one Physical Resource Block (PRB) or several PRBs based. The block size selection is a trade-off between performance and complexity. A larger block size is chosen, a better interference estimation can be obtained but with higher complexity. FIG. 3 is an example in the LTE/LTE-A system for extracting the polluted data (i.e. data suffering from interference) in one PRB so as to form the first set of plurality of data symbols associated with the serving cell.

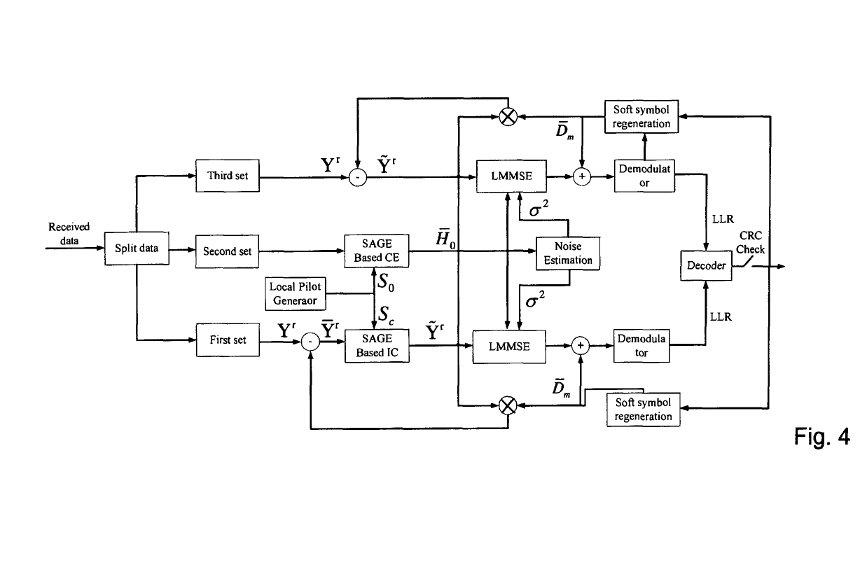

For each block size, after extraction of the received data at the polluted positions, the received signal model can be described as

$${Y}^{r} = {\sum }_{m = 0}^{M - 1} {D}^{m} {H}_{0}^{m , r} + {\sum }_{c = 1}^{C - 1} {S}_{c} {H}_{c}^{r} + W , 0 \leq r < R \qquad ( 15 )$$

where H₀^{m,r}=(h₀^{m,r}(0), h₀^{m,r}(1), . . . , h₀^{m,r}(K−1))^{T} is the column vector of CSI corresponding to m-th transmit antenna and r-th receive antenna of the serving cell, D^{m}=diag(d^{m}(0), d^{m}(1), . . . d^{m}(K−1)) is the diagonal matrix of the data transmitted on m-th transmit antenna of severing cell, S_{c} and Δp_{c} are defined the same as in equation (2). H_{c}^{r}=(h′_{c}(0), h′_{c}(1), . . . , h_{c}^{r}(K−1))^{T} is the column vector of CSI of interfering cell of the r-th receive antenna which needs to be estimated, W=(w(0), w(1), . . . w(K−1))^{T} is the column vector of AWGN and K is total number extracted from the block area that is considered for interference estimation as showed in FIG. 4.

The serving cell CSI H₀^{m,r} has been obtained through the pilot-based CE of the second set. Because the pilot symbols S_{c}(1≦c<C) of the interfering cells are all known at receiver side, the SAGE-MAP algorithm can be used to estimate the CSI H_{c}^{r}(1≦c<C) by regarding the rest serving cell data plus noise part as noise,

TABLE 1
SAGE-MAP algorithm

| for r = 0: R − 1 | |
|---|---|
| Initialization: | |
| Initialize H_{c}^{r} (1 ≦ c < C); | |
| $e = {Y}^{r} - {\sum }_{c = 1}^{C - 1} {S}_{c} {H}_{c}^{r} ;$ | |
| for i = 0: SAGEIterNum | |
| for c = 1:C-1 | |
| E − Step: | Ŷ_{c} = e + S_{c}H_{c}^{r} |
| | $Σ = E ( {ee}^{H} ) \approx \frac{1}{K} ( {e}^{H} e ) {I}_{K} = {σ}^{2} {I}_{K}$ |
| M − Step: | ${\overline{H}}_{c}^{r} = {{R}_{c} ( {R}_{c} + \frac{{σ}^{2}}{Δ {p}_{c}} {I}_{K} )}^{- 1} \frac{{S}_{c}^{H}}{Δ {p}_{c}} {\hat{Y}}_{c}$ |
| | e = Ŷ_{c} − S_{c} H̅_{c}^{r} |
| | H_{c}r = H̅_{c}^{r} |

```
        end
    end
  e^{r} = e;
end
Output e^{r}, H̅_{c}^{r}, 1 ≦ c < C, 0 ≦ r < R
```

H_{c}^{r} is initialized as zeros in the beginning of the algorithm and later is initialized as the output from SAGE-MAP of the previous iteration. After obtaining the CE H_{c}^{r}(0≦r<R) from the SAGE-MAP iteration, the pilot interference can thus be removed from received signal before serving cell data detection,

$${Y}^{r} - {\sum }_{c = 1}^{C - 1} {S}_{c} {\overline{H}}_{c}^{r} = {\sum }_{m = 0}^{M - 1} {D}^{m} {H}_{0}^{m , r} + {\sum }_{c = 1}^{C - 1} {S}_{c} ( {H}_{c}^{r} - {\overline{H}}_{c}^{r} ) + W = {e}^{r} \qquad ( 16 )$$

Table 1 can also be used for SAGE-MAP based CE of serving cell pilots by substituting the equation (15) with equation (2). For SAGE-MAP based CE only the serving cell CE needs to be outputted and for SAGE based IC the data e^{r} from which the estimated interference has been removed also needs to be outputted.

Iterative data detection and interference estimation

The received signal y̅ᵣ(k) (fetched from e^{r} output from SAGE-MAP based IC module) after removing the estimated interference at frequency index k of r-th receive antenna can be described as,

$${\overline{y}}_{r} ( k ) = {\sum }_{m = 0}^{M - 1} {d}_{m} ( k ) {h}_{rm} ( k ) + {n}_{r} ( k ) \qquad ( 17 )$$

where dₘ(k) is the transmitted signal at frequency index k from transmit antenna m and hᵣₘ(k) is the corresponding channel of transmit antenna m and receive antenna r. nᵣ(k) is the residual interference plus noise which is regarded as AWGN for the sake of process simplicity.

Denote Ŷ(k)=( y̅₀(k), y̅₁(k), . . . y̅_{R-1}(k))^{T} as the received signal vector of R receive antennas, D(k)=(d₀(k), d₁(k), . . . , d_{M-1}(k))^{T} as the transmitted signal vector of M transmit antennas, Hₘ(k)=(h₀ₘ(k), h₁ₘ(k), . . . h_{(R-1)m}(k))^{T} as the CSI vector of R receive antennas corresponding to transmit antenna m and N(k)=(n₀(k), n₁(k), . . . n_{K-1}(k))^{T} as the noise vector of R receive antennas. The received signal model for the R receive antennas at frequency index k is thus described as,

\hat{Y}(k)=(H₀(k),H₁(k), . . . ,H_{M-1}(k))D(k)+N(k) (18)

The normalized LMMSE is utilized for data detection and it is given as,

$${\overline{d}}_{n} ( k ) = \frac{{( {H}_{n} ( k ) )}^{H} {( {\sum }_{m = 0}^{M - 1} {H}_{m} ( k ) {( {H}_{m} ( k ) )}^{H} + {σ}_{N}^{2} I )}^{- 1}}{{( {H}_{n} ( k ) )}^{H} {( {\sum }_{m = 0}^{M - 1} {H}_{m} ( k ) {( {H}_{m} ( k ) )}^{H} + {σ}_{N}^{2} I )}^{- 1} {H}_{n} ( k )} \tilde{Y} ( k ) \qquad ( 19 )$$

After equalization the serving cell data estimation based on equation (19) for all polluted positions can be feedback and removed from received signal. Assuming D̅^{m} is the obtained estimation of D^{m} in equation (15), the serving cell data can thus be removed,

$${\overline{Y}}^{r} = {Y}^{r} - {\sum }_{m = 0}^{M - 1} {\overline{D}}^{m} {H}_{0}^{m , r} = {\sum }_{m = 0}^{M - 1} ( {D}^{m} - {\overline{D}}^{m} ) {H}_{0}^{m , r} + {\sum }_{c = 1}^{C - 1} {S}_{c} {H}_{c}^{r} + W \qquad ( 20 )$$

Because the serving cell data is partly removed from the received signal, the improved interference estimation can be obtained if re-run the SAGE-MAP in Table 1 based on new input data Y̅^{r}. Thus equation (19), equation (20) and Table 1 give an iterative scheme for pilot interference cancellation according to the present disclosure.

LMMSE-PIC Based Data Detection

Furthermore, the bit LLR output from the demodulator or decoder units can be used to regenerate the transmit symbols D̅(k)=( d̅₀(k), d̅₁(k), . . . d̅_{M-1}(k))^{T} (i.e. “soft symbol”), which has better quality than the data estimation given in equation (19). Meanwhile, the LMMSE-PIC algorithm can be employed to boost the data detection performance which is described briefly as follows.

The bit LLR output from demodulator or decoder is defined as \tilde{Λ}_{q}=InP(b_{q}=1)−InP(b_{q}=0). The probability of symbol s mapped from bit b₀, b₁, . . . , b_{Q-1} is calculated by

$$p ( s {b}_{0} {b}_{1} … {b}_{Q - 1} ) = {\prod }_{q = 0}^{Q - 1} \frac{exp ( {b}_{q} {\tilde{Λ}}_{q} )}{1 + exp ( {\tilde{Λ}}_{q} )} ,$$

b_{q} equals to 0 or 1 and Q is bit number mapped to one symbol. The soft symbol is calculated by

$$\tilde{s} = E ( s ) = {\sum }_{s ∈ Θ} ( s * p ( s {b}_{0} {b}_{1} … {b}_{Q - 1} ) )$$

and Θ is the Gray mapping set. The symbol estimation variance is given by

$$var ( s ) = E ( {\vert s \vert}^{2} ) - {\vert E ( s ) \vert}^{2} = {\sum }_{s ∈ Δ} ( {\vert s \vert}^{2} * p ( s {b}_{0} {b}_{1} … {b}_{Q - 1} ) ) - \vert {\sum }_{s ∈ Δ} s * p ( s {b}_{0} {b}_{1} … {b}_{Q - 1} ) \vert .$$

This assumes that D̅(k)=( d̅₀(k), d̅₁(k), . . . , d̅_{M-1}(k))^{T} is the soft symbol and var(dₘ(k)) is the symbol variance for soft symbol d̅ₘ(k) (0≦m<M). First, the soft symbol is removed from the received signal in equation (18) and denoted as Δ\tilde{Y}(k)=\tilde{Y}(k)− D̅(k), then the normalized LMMSE-PIC based estimation of D(k) is given as,

$$\begin{matrix}{\tilde{d}}_{n} ( k ) = {\overline{d}}_{n} ( k ) + \frac{{( {H}_{n} ( k ) )}^{H} {( \begin{matrix}{\sum }_{m = 0}^{M - 1} var ( {d}_{m} ( k ) ) {H}_{m} ( k ) \\ {( {H}_{m} ( k ) )}^{H} + {σ}_{N}^{2} I\end{matrix} )}^{- 1}}{{( {H}_{n} ( k ) )}^{H} {( \begin{matrix}{\sum }_{m = 0}^{M - 1} var ( {d}_{m} ( k ) ) {H}_{m} ( k ) \\ {( {H}_{m} ( k ) )}^{H} + {σ}_{N}^{2} I\end{matrix} )}^{- 1} {H}_{n} ( k )} Δ \tilde{Y} ( k ) \\ = {\overline{d}}_{n} ( k ) + \frac{{( {H}_{n} ( k ) )}^{H} {( \begin{matrix}{\sum }_{m \neq n}^{M - 1} var ( {d}_{m} ( k ) ) {H}_{m} ( k ) \\ {( {H}_{m} ( k ) )}^{H} + {σ}_{N}^{2} I\end{matrix} )}^{- 1}}{{( {H}_{n} ( k ) )}^{H} {( \begin{matrix}{\sum }_{m \neq n}^{M - 1} var ( {d}_{m} ( k ) ) {H}_{m} ( k ) \\ {( {H}_{m} ( k ) )}^{H} + {σ}_{N}^{2} I\end{matrix} )}^{- 1} {H}_{n} ( k )} Δ \tilde{Y} ( k )\end{matrix} , \\ 0 \leq n < M \qquad ( 21 )$$

The last identity in equation (21) comes from the fact that, for arbitrary complex scalar α:

$$\frac{{{u}^{H} ( V + {auu}^{H} )}^{- 1}}{{{u}^{H} ( V + {auu}^{H} )}^{- 1} u} = \frac{{u}^{H} {V}^{- 1}}{{u}^{H} {V}^{- 1} u} .$$

It can be obtained directly from the Sherman-Morrison formula. This also implies that when M=1, with any data feedback information, equation (21) is equivalent to equation (19). So the LMMSE-PIC itself will not provide any help for the data detection when M=1 (i.e. the single transmit antenna case), but as the interference estimation has been refined (meaning that the data input to equalizer contains less interference) the equalization performance is still improved.

Iterative Pilot Interference Cancellation Scheme

Combining the analysis in section A-E above, an iterative pilot interference cancellation scheme according to the present disclosure is described as follows.

Step 0: Use the SAGE-MAP algorithm described in Table 1 to process the received second signal set to obtain the CE of the pilot symbols. Then the CE for data part and noise density estimation σ² is obtained based on the CE of the pilot symbols.

Step 1: In the first iteration step, there is no data feedback. Thus, regard the serving data as noise and use the SAGE-MAP in Table 1 on the originally received signal Y^{r}(0≦r<R) to estimate and remove the interference from the received first signal set. For the received third signal set there is no process needed and is therefore sent directly to the equalizer.

Step 2: A normalized LMMSE in equation (19) is used for data detection for the received first and third signal sets.

Step 3: According to the embodiment denoted “Method 1”, the data after equalization is fed back directly and removed from the originally received signal Y^{r}(0≦r<R)) for both the first and third signal sets.

According to the embodiment denoted “Method 2”, the data after equalization is sent to the demodulator module and the bit LLR is calculated. Based on the output bit LLR the soft estimation of the serving cell data is reconstructed and removed from the original received signal Y^{r}(0≦r<R) for both the first and third signal sets.

According to the embodiment denoted “Method 3”, the data after equalization is sent to the demodulator module and then further sent to the decoder. Based on the bit LLR output from the decoder the soft symbol estimation of the serving cell data is reconstructed and removed from the original received signal Y^{r}(0≦r<R)) for both the first and third signal sets.

Step 4: Denote the data after removing the serving cell feedback data as Y̅^{r}(0≦r<R) and repeat Step 1 and Step 2 based on data Y̅^{r}.

Step 5: Repeat Step 3 and Step 4 until reaching the pre-defined iteration number. The soft symbol estimation of serving cell data that was removed in Step 3 is added back to the data output in Step 4 before entering the demodulator at each time.

Embodiment of FIG. 3: Method 2

The present method comprises, according to an embodiment (i.e. Method 2), the further steps of demodulating the first set, and regenerating the demodulated first set so as to obtain a soft estimation of the plurality of data symbols and their respective variances in the first set. Hence, in this embodiment the bit LLR values output from data demodulator are used to regenerate the transmitted symbol. The regenerated symbols are used to replace the symbol used in the main method (i.e. Method 1) for iteration. As the data symbols regenerated from bit LLR output from the data demodulator are more accurate than the data symbols obtained after equalization, Method 2 thus provides a better performance than Method 1. Moreover, under low SNR region, the data symbols obtained after equalization can be very bad, which limits the performance of Method 1 and makes Method 2 more applicable.

Furthermore, the LMMSE-PIC method is used in the equalizer to improve the data detection performance. The embodiment is an iteration scheme between the interference estimation module, the serving cell data equalization module and demodulator. This means that a third set is extracted from the superimposed signal, wherein the third set comprises a plurality of data symbols associated with the serving cell which are not affected by interference. The third set is demodulated combined with the second demodulated set. Finally, the combined set is decoded.

A receiver structure for this embodiment is shown in FIG. 3. The received signal is first split into the three sets explained above. The second set contains the pilot symbols of the serving cell and the SAGE-MAP based CE as described in Table 1 is employed for serving cell CE. The third set contains the serving cell data symbols which are interference free and the LMMSE-SPIC is employed for data detection. The first set contains the serving cell data symbols which suffer from interference and the SAGE-MAP based IC as described in Table 1 is employed for interference estimation and cancellation, and LMMSE-SPIC is also employed for data detection. The serving cell data symbols feedback is regenerated from the bit LLR that is output from the demodulator. After iterating the pre-defined iteration numbers, the bit LLR is finally sent to decoder for decoding. In a real scenario, either the first set or the third set can be empty which means the corresponding process blocks can be therefore by-passed.

Embodiment of FIG. 4: Method 3

The present method comprises, according to another embodiment (i.e. Method 3), the further steps of extracting a third set from the superimposed signal, wherein the third set comprises a plurality of data symbols associated with the serving cell which are not affected by interference. The third set is thereafter demodulated. Step e) in the main method further involves demodulating the first set and combining the first and third demodulated sets, and decoding the combined set. Finally the decoded first set is regenerated so as to obtain a soft estimation of the plurality of data symbols and their respective variances in the first set.

In this embodiment the bit LLR values output from decoder are used instead of the demodulator to regenerate the transmitted symbol. As the bit LLR from decoder is more accurate than the bit LLR from demodulator, the regenerated data symbols are better than that in Method 2. The embodiment is an iteration scheme between the interference estimation module, the serving cell data equalization module, demodulator and decoder as showed in FIG. 4.

A receiver structure for this embodiment is shown in FIG. 4. The whole structure is similar to FIG. 3 except for the data symbols feedback is regenerated from the bit LLR that is output from the decoder. And prior to that, a CRC check is implemented. If the CRC of all the data streams are correct, then the iteration process is ended. Otherwise, the iteration process is continued until the CRC is correct or reaches the pre-defined iteration number. In a real scenario, either the first set or the third set can be empty which means the corresponding process blocks can be therefore by-passed.

Some Performance Results

The performance of the present disclosure compared to prior art in FDD LTE ABS scenario with 10 MHz bandwidth configuration in downlink was studied. The transmission mode was Open Loop Spatial Multiplexing (OLSM) and Hybrid Automatic Repeat Request (HARM) process was activated with maximal 4 transmissions. Further, Quadratic Amplify Modulation (16QAM) modulation was used and the coding rate was 0.5. Two transmit and two receive antennas were used for the simulations, and the channel type was Extended Vehicular A model (EVA) with 5 hertz (Hz) Doppler.

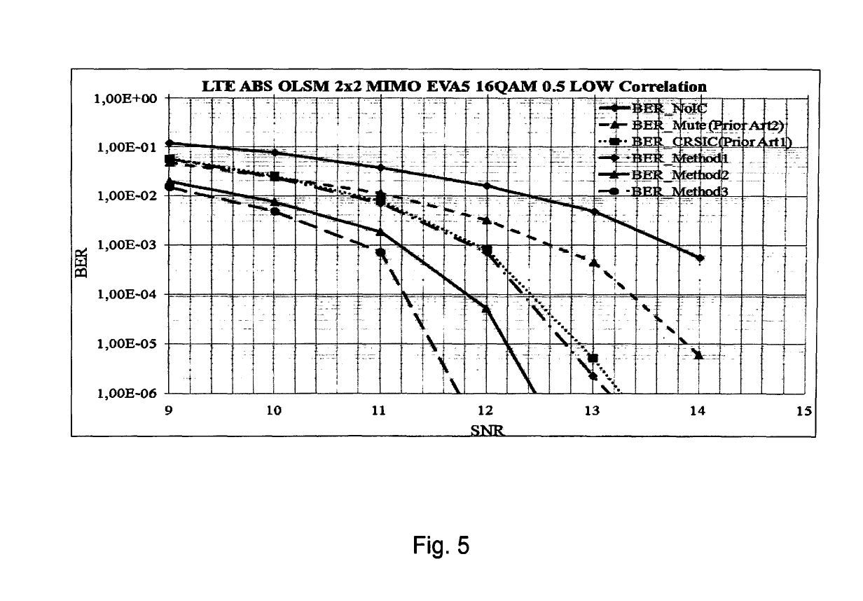

In the first simulations as shown in FIG. 5, two interfering cells with cell ID [7, 1] were considered. Both of them are interfering with data symbols of the serving cell. The transmitted power of interference cells was [6, 6] decibel (dB) higher than the noise density. Two iterations were used for iterative interference cancellation for Method 1, Method 2 and Method 3. The number of SAGE iterations was set to 4 for the interference estimation in each iteration step and the block size for interference estimation is one PRB. For the serving cell, perfect CSI and noise estimation were assumed for data detection.

As shown in FIG. 5 the present disclosure outperforms prior art 1 (denoted as “CRSIC” (common reference signal interference cancellation) in FIG. 5) and prior art 2 (denoted as “Mute” in FIG. 5) described earlier in the present disclosure. Major gain can be observed compared with no interference cancellation receiver (denoted as “NoIC” (no interference cancellation) in FIG. 5). Further, as predicted Method 3 has the best performance and Method 2 surpasses the performance of Method 1. But as Method 3 has the highest complexity, and hence for a detailed receiver node design, Method 2 or even Method 1 can be used as an alternative to Method 3 for reducing the computation complexity and process latency. Although Method 1 and Method 2 are suffering performance losses compared to Method 3 they can still provide performance gain over priori art and no interference cancellation receiver as the simulation results shows.

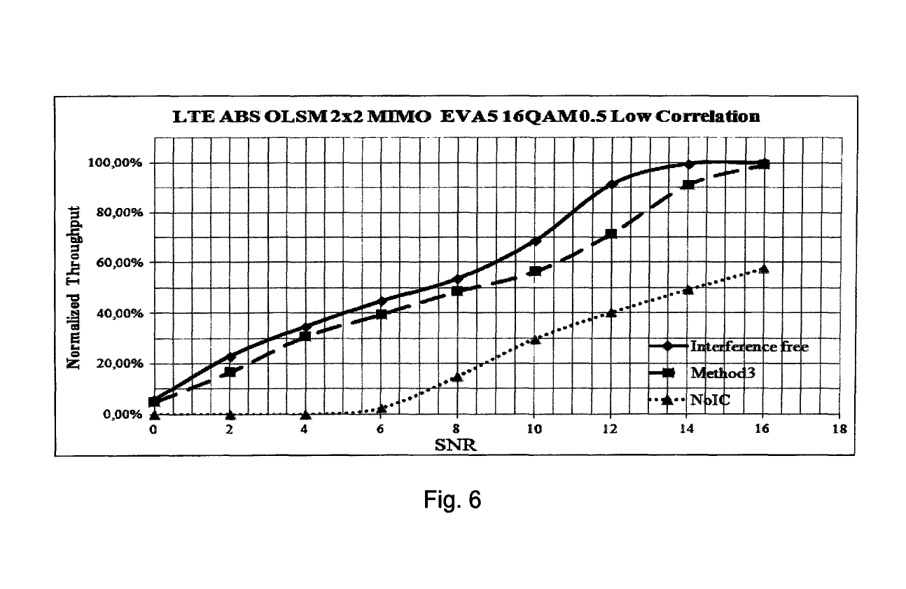

In the second simulations four interfering cells with cell ID [6, 7, 13, 14] were studied. The transmitted power of the interfering cells was [6, 12, 10, 6] higher than the noise density. Two iterations were used for iterative interference cancellation of Method 3. SAGE iteration number was 2 and the block size used was 5 PRBs for both the serving cell CSI estimation and interference estimation. Huge gain can be obtained compared with no interferes cancellation (denoted as “NoIC” in FIG. 6) and is only less than 2 dB loss compared with the single cell case (i.e. “interference free” in FIG. 6) which is also with LMMSE-PIC two iterations.

Furthermore, as would be understood by one skilled in the art, any method according to the present disclosure may also be implemented in a computer program, having code means (e.g., software code), which when run by processing means (e.g., a processor) causes the processing means to execute the steps of the method. The computer program is included in a computer readable medium of a computer program product. The computer readable medium may comprises of any memory such as a Read-Only Memory (ROM), a Programmable Read-Only Memory (PROM), an Erasable PROM (EPROM), a Flash memory, an Electrically Erasable PROM (EEPROM), or a hard disk drive.

The present disclosure also relates to a receiver node device arranged to perform the method steps according to any embodiment of the present disclosure. Three explicit embodiments are shown in FIGS. 2-4.

The present device is arranged and comprises the suitable means for performing any method according to the present disclosure including all explicit and implicit embodiments. Examples of suitable means are: a processor, a memory, an antenna, a transmitter, a splitter/extractor, an input, an output, interference removing means, estimating means, subtraction means, and connection means for transmission of signals between the different means or any other functional units. The receiver means may be a mobile station or a relay device.

The receiving means are arranged for receiving a superimposed signal comprising pilot symbols and data symbols associated with a serving cell and pilot symbols associated with one or more interfering cells. The extracting means are arranged for extracting a first set from the superimposed signal, wherein the first set comprises a plurality of data symbols associated with the serving cell which are affected by an interference from the one or more interfering cells. The estimating means are arranged for estimating an interference of the first set. The removing means are arranged to removing interference from the first set by means of the estimated interference The estimating means arranged for estimating the plurality of data symbols. The subtracting means are arranged for subtracting the estimated plurality of data symbols from the first set. The repeating means are arranged so that steps c)-f) are repeated i number of times, where i≧1.

Finally, it should be understood that the present disclosure is not limited to the embodiments described above, but also relates to and incorporates all embodiments within the scope of the appended independent claims.

1. An iterative pilot symbol interference cancellation method in a receiver node of a cellular wireless communication system, said receiver node being arranged to receive one or more superimposed signals originating from at least one serving cell and one or more interfering cells, said method comprising the steps of:
receiving a superimposed signal comprising pilot symbols and data symbols associated with a serving cell and pilot symbols associated with one or more interfering cells;
extracting a first set from said superimposed signal, wherein said first set comprises a plurality of data symbols associated with said serving cell which are affected by an interference from said one or more interfering cells;
estimating an interference of said first set;
removing interference from said first set using the estimated interference;
estimating said plurality of data symbols;
subtracting the estimated plurality of data symbols from said first set; and
repeating the estimating an interference, the removing interference, the estimating plurality of data symbols, and the subtracting steps i number of times, where i≧1.

2. The method according to claim 1, wherein the estimating an interference and the removing interference steps are performed according to a Space-Alternating Generalized Expectation-Maximization with Maximum a Posterior (SAGE-MAP) method.

3. The method according to claim 1, wherein the estimating plurality of data symbols step is performed according to a Linear Minimum Mean Square Error with Parallel Interference Cancellation(LMMSE-PIC) method.

4. The method according to claim 1, wherein the estimating an interference step involves:
extracting a second set from said superimposed signal, wherein said second set comprises pilot symbols associated with said serving cell which are affected by the interference from said one or more interfering cells; and
using said second set for channel and noise estimation of said one or more interfering cells.

5. The method according to claim 1, wherein the estimating plurality of data symbols step involves:
demodulating said first set; and
regenerating said demodulated first set so as to obtain a soft estimation of said plurality of data symbols and their respective variances in said first set.

6. The method according to claim 5, further comprising the steps of:
extracting a third set from said superimposed signal, wherein said third set comprises a plurality of data symbols associated with said serving cell which are not affected by interference;
demodulating said third set;
combining said second and third demodulated sets; and
decoding said combined set.

7. The method according to claim 1, further comprising the steps of:
extracting a third set from said superimposed signal, wherein said third set comprises a plurality of data symbols associated with said serving cell which are not affected by interference; and
demodulating said third set,
wherein the estimating plurality of data symbols step involves:
demodulating said first set;
combining said first and third demodulated sets;
decoding said combined set; and
regenerating said decoded first set so as to obtain a soft estimation of said plurality of data symbols and their respective variances in said first set.

8. The method according to claim 1, wherein said cellular wireless communication system is an OFDM system, such as a 3GPP LTE system.

9. The method according to claim 8, wherein said receiver node is a mobile station node or a relay node.

10. A computer program product comprising computer executable instructions stored on a non-transitory medium that when executed by a processor cause the processor to execute an iterative pilot symbol interference cancellation comprising the steps of:
receiving a superimposed signal comprising pilot symbols and data symbols associated with a serving cell and pilot symbols associated with one or more interfering cells;
extracting a first set from said superimposed signal, wherein said first set comprises a plurality of data symbols associated with said serving cell which are affected by an interference from said one or more interfering cells;
estimating an interference of said first set;
removing interference from said first set using the estimated interference;
estimating said plurality of data symbols;
subtracting the estimated plurality of data symbols from said first set; and
repeating the estimating an interference, the removing interference, the estimating plurality of data symbols, and the subtracting steps i number of times, where i≧1.

11. The computer program product according to claim 10, wherein the estimating an interference and the removing interference steps are performed according to a Space-Alternating Generalized Expectation-Maximization with Maximum a Posterior(SAGE-MAP) method.

12. The computer program product according to claim 10, wherein the estimating plurality of data symbols step is performed according to a Linear Minimum Mean Square Error with Parallel Interference Cancellation(LMMSE-PIC) method.

13. The computer program according to claim 10, wherein the estimating an interference step involves:
extracting a second set from said superimposed signal, wherein said second set comprises pilot symbols associated with said serving cell which are affected by the interference from said one or more interfering cells; and
using said second set for channel and noise estimation of said one or more interfering cells.

14. The computer program product according to claim 10, wherein the estimating plurality of data symbols step involves:
demodulating said first set; and
regenerating said demodulated first set so as to obtain a soft estimation of said plurality of data symbols and their respective variances in said first set.

15. The computer program product according to claim 14, further comprising the steps of:
extracting a third set from said superimposed signal, wherein said third set comprises a plurality of data symbols associated with said serving cell which are not affected by interference;
demodulating said third set;
combining said second and third demodulated sets; and
decoding said combined set.

16. The computer program product according to claim 10, further comprising the steps of:
extracting a third set from said superimposed signal, wherein said third set comprises a plurality of data symbols associated with said serving cell which are not affected by interference; and
demodulating said third set,
wherein the estimating plurality of data symbols step) involves:
demodulating said first set;
combining said first and third demodulated sets;
decoding said combined set; and
regenerating said decoded first set so as to obtain a soft estimation of said plurality of data symbols and their respective variances in said first set.

17. The computer program product according to claim 10, wherein said cellular wireless communication system is an Orthogonal Frequency Division Multiplexing (OFDM) system, such as a 3rd Generation Partnership Project Long-Term Evolution (3GPP LTE) system.

18. The computer program product according to claim 17, wherein said receiver node is a mobile station node or a relay node.

19. The computer program product according to claim 10, wherein the non-transitory medium comprises of one or more of a Read-Only Memory (ROM), Programmable ROM (PROM), Erasable PROM (EPROM), Flash memory, Electrically EPROM (EEPROM), and hard disk drive.

20. A receiver node device of a cellular wireless communication system, said receiver node comprising processing means and memory means and being arranged to receive one or more superimposed signals originating from at least one serving cell and one or more interfering cells, and said receiver node device further comprising:
a) receiving means arranged for receiving a superimposed signal comprising pilot symbols and data symbols associated with a serving cell and pilot symbols associated with one or more interfering cells;
b) extracting means arranged for extracting a first set from said superimposed signal, wherein said first set comprises a plurality of data symbols associated with said serving cell which are affected by an interference from said one or more interfering cells;
c) estimating means arranged for estimating an interference of said first set;
d) removing means arranged to removing interference from said first set by means of the estimated interference;
e) estimating means arranged for estimating said plurality of data symbols;
f) subtracting means arranged for subtracting the estimated plurality of data symbols from said first set; and
repeating means arranged so that the estimating an interference, the removing interference, the estimating plurality of data symbols, and the subtracting steps are repeated i number of times, where i≧1.
